(19) United States
(12) Patent Application Publication
(10) Pub. No.: US 2004/0193535 A1
(43) Pub. Date: Sep. 30, 2004

(54) Global failure risk score

(76) Inventor: Reza Barazesh, West Windsor, NJ (US)

Correspondence Address: Paul D. Greeley, Esq., Ohlandt, Greeley, Ruggiero & Perle, L.L.P., 10th Floor, One Landmark Square, Stamford, CT, 06901-2682, US

(21) Appl. No.: 10/397,823

(22) Filed: Mar. 26, 2003

(51) Int. Cl. G06F 17/60

(52) U.S. Cl. 705/38

(57) ABSTRACT

A method of providing a score includes computing a base from local country failure risk scores from included countries. The base is mapped to global failure risk scores based on a probability of failure. The global failure risk scores are translated to a globally standardized score and globally standardized score is provided.

### BACKGROUND

1. Field of the Invention

The present invention relates to providing business information, and more particularly, to providing risk scores.

2. Description of the Related Art

Dun & Bradstreet's current local country scoring solutions fulfill their customer's local company scoring needs. However, if their customers have multinational customer and vendor portfolios, they cannot use the domestic scores to compare the risk of companies from different countries. For example, the current Dun & Bradstreet local failure risk score for a company in Germany cannot be compared with the Dun & Bradstreet local failure risk score for a company in Italy, because domestic scores have different scales, i.e., score ranges. The same score can correspond to different probabilities of failure within different countries. There is a need for a global failure risk score that has the same probability of failure for all countries.

The present invention has many advantages, including providing customers with a way to assess company failure risk when dealing with companies across borders. Companies are evaluates from different countries in a logical and consistent manner. Credit decision-making processes are standardized for consistency and for potential cost savings. Exposure is assessed globally with a consistent measure of risk across borders. Profitable prospects are identified globally. With the global failure risk score, customers are able to analyze their multinational portfolio. The global failure risk score provides a uniform tool for comparing the failure risk of companies in different countries.

These and other features, aspects, and advantages of the present invention will become better understood with reference to the drawings, description, and claims.

### SUMMARY

One embodiment of the present invention is a method of providing a score. A base is computed from local country failure risk scores from included countries. The base is mapped to global failure risk scores based on a probability of failure. The global failure risk scores are translated to a globally standardized score and globally standardized score is provided.

In another embodiment, the step of mapping the base to the global failure risk scores and the step of translating the global failure risk scores to the globally standardized score are performed by several steps. First, a percentile score corresponding to the probability of failure is computed. Second, the percentile score is mapped to each of the global failure risk scores. Finally, the percentile score is translated to the globally standardized score.

In still another embodiment, the step of mapping the percentile score to each of the global failure risk scores results in at least one calibration table for each of the plurality of included countries. In still another embodiment, method of providing a score further comprises providing a global delinquency score. In still another embodiment, the globally standardized score is a uniform measure, predicting the risk of failure in the included countries. In still another embodiment, the globally standardized score predicts a likelihood of a firm ceasing businesses without paying all creditors in full over a next 12 month period.

In still another embodiment, the included countries are selected from the group consisting of Austria, Belgium, Denmark, France, Germany, Ireland, Italy, Netherlands, Norway, Portugal, Spain, Switzerland, and United Kingdom. In still another embodiment, the included countries are selected from the group consisting of United States and Canada. In still another embodiment, the included countries are selected from the group consisting of Australia, Hong Kong, Israel, Japan, and South Africa.

In still another embodiment, the global failure risk score is a raw score. In still another embodiment, the global failure risk score as a four digit scale. In still another embodiment, the four digit scale starts from 1001-1850.

These and other features, aspects, and advantages of the present invention will become better understood with reference to the drawings, description, and claims.

### BRIEF DESCRIPTION OF THE DRAWINGS

FIG. 1 is a block diagram of a method of providing a score according to the present invention.

### DETAILED DESCRIPTION

In the following detailed description, reference is made to the accompanying drawings. These drawings form a part of this specification and show by way of example specific preferred embodiments in which the present invention may be practiced. These embodiments are described in sufficient detail to enable those skilled in the art to practice the present invention. Other embodiments may be used and structural, logical, and electrical changes may be made without departing from the spirit and scope of the present invention. Therefore, the following detailed description is not to be taken in a limiting sense and the scope of the present invention is defined only by the appended claims.

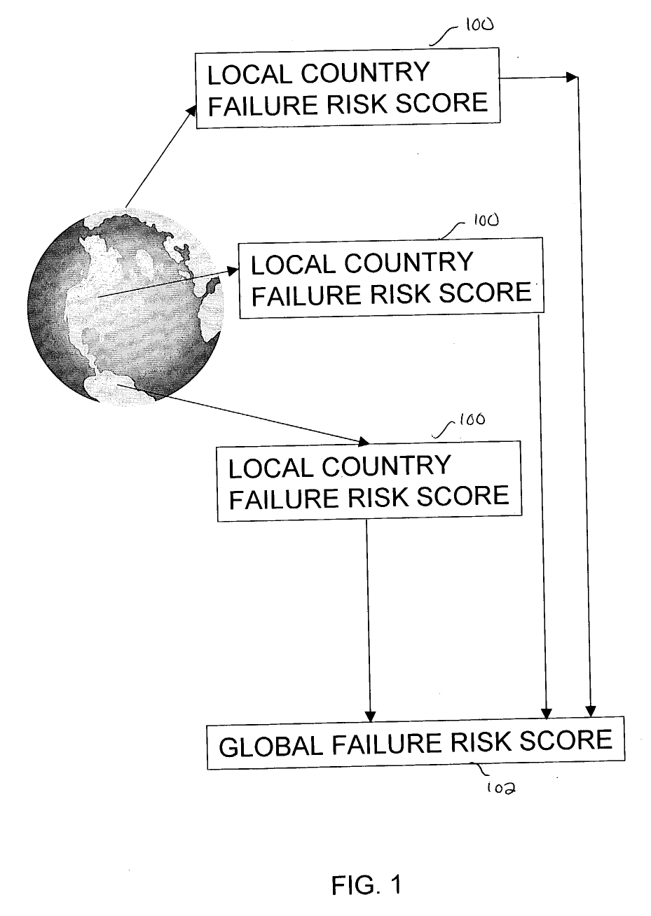

FIG. 1 shows a method of providing a score according to the present invention. Local country failure risk scores 100 from various countries are transformed into global failure risk scores 102. Global failure risk score 102 predicts the likelihood of a company ceasing business without paying all creditors in full over a time period, such as the next 12 months. From country to country, there will be variations in the definition of failure risk scores. For example, the United States' score includes reorganization or obtaining relief from creditors under state or federal law.

Global failure risk score 102 is defined as a single uniform measure predicting risk of failure in any included countries. Included countries are those countries that have a statistical model that predicts business failure for companies within that country. Global failure risk score 102 is available as a raw score with a four-digit scale starting from 1001-1850. Global failure risk score 102 is not the result of a new scoring model. Local country failure risk scores 100 are mapped to global failure risk score 102 based on the probability of failure.

In addition, a global delinquency score is sometimes provided with global failure risk score 102. The global delinquency score is a uniform measure predicting delinquency risk in any included country.

Local country failure risk scores 100 from these countries provide a base for the global failure risk score: Australia, Belgium, Denmark, France, Germany, Italy, Netherlands, Portugal, Spain, United Kingdom, United States, Canada, Japan, and Hong Kong. The countries with local country failure risk scores 100 are Austria, Belgium, Denmark, France, Germany, Ireland, Italy, Netherlands, Norway, Portugal, Spain, Switzerland, and United Kingdom, United States, Canada, Australia, Hong Kong, Israel, Japan, and South Africa.

For example, a percentile score of 5% in country A corresponds to a probability of failure of 0.4%. A percentile score of 10% in country B also corresponds to a 0.4% probability of failure. These two percentile scores from two different countries are mapped to the same global failure risk score 102. This score mapping results in calibration tables for all the included countries. Global failure risk score calibration tables translate a local percentile score to a globally standardized score (global failure risk score 102).

Local country failure risk scores 100 are mapped to global failure risk score 102 based on the probability of failure. Global failure risk score calibration tables translate a local score to a globally standardized score. The table below demonstrates the calibration using two different country scores whose probability of failure is equal. Country C and country D have the same marginal odds (same probability of failure) across borders.

| | Country C | | Country D | | Global |
|---|---|---|---|---|---|
| Country C | Percentile | Country D | Percentile | Probability | Failure |
| Scores | Score | Scores | Score | of Failure | Score |
| 1323 | 5% | 1314 | 10% | 0.4 | 1319 |
| 1325 | 6% | 1331 | 12% | 0.45 | 1330 |

Global failure risk scores 102 are available to customers who use the data integration platform in products available from Dun & Bradstreet, Short Hills, N.J., such as global failure risk score, decision support, enterprise, and vendor management. The uniform and globally standardized global failure risk score 102 is delivered together with local country failure risk score 100. For example, when a customer orders the global failure risk score product for a French company, they receive the local French failure risk score for this company telling them how that business measures as compared to other businesses in France. Global failure risk score 102 is used together with local country failure risk score 100 in customer applications, such as global portfolio analysis and approval rate cutoffs by country.

An example method for mapping the base to global failure risk scores based on a probability of failure and translating the global failure risk scores to a globally standardized score is: (1) sorting, in descending order, each country's score by probability of the predicted event; (2) dividing the resulting score distribution into about 20 groups of about 5% intervals; (3) identifying the score at the midpoint of each of the about 20 intervals; and (4) using this score as a re-scaled score for that country.

In addition to global failure risk score 102, a global failure risk score data view has other information, including demographics information, payment information, special events information, financial information, evaluation data, and local country failure risk score percentile information. Information available for global failure risk score 102 includes sales resource guide, customer manual, customer presentation, and faxable brochure.

It is to be understood that the above description is intended to be illustrative and not restrictive. Many other embodiments will be apparent to those of skill in the art upon reviewing the above description, including other ways of combining scores and other similar differences. The present invention has applicability to many applications of providing failure risk scores. Therefore, the scope of the present invention should be determined with reference to the appended claims, along with the full scope of equivalents to which such claims are entitled.

What is claimed is:

1. A method of providing a score, comprising:
computing a base from a plurality of local country failure risk scores from a plurality of included countries;
mapping said base to global failure risk scores based on a probability of failure;
translating said global failure risk scores to a globally standardized score; and
providing said globally standardized score.

2. The method according to claim 1, wherein said step of mapping said base to said global failure risk scores and said step of translating said global failure risk scores to said globally standardized score, comprises:
computing a percentile score corresponding to said probability of failure;
mapping said percentile score to each of said global failure risk scores; and
translating said percentile score to said globally standardized score.

3. The method according to claim 2, wherein said mapping said percentile score to each of said global failure risk scores results in at least one calibration table for each of said plurality of included countries.

4. The method according to claim 1, further comprising:
providing a global delinquency score.

5. The method according to claim 1, wherein said globally standardized score is a uniform measure, predicting a risk of failure in said included countries.

6. The method according to claim 3, wherein said globally standardized score predicts a likelihood of a firm ceasing businesses without paying all creditors in full over a next 12-month period.

7. The method according to claim 1, wherein said included countries are selected from the group consisting of Austria, Belgium, Denmark, France, Germany, Ireland, Italy, Netherlands, Norway, Portugal, Spain, Switzerland, and United Kingdom.

8. The method according to claim 1, wherein said included countries are selected from the group consisting of United States and Canada.

9. The method according to claim 1, wherein said included countries are selected from the group consisting of Australia, Hong Kong, Israel, Japan, and South Africa.

10. The method according to claim 1, wherein said global failure risk score is a raw score.

11. The method according to claim 10, wherein said global failure risk score has a four digit scale.

12. The method according to claim 11, wherein said four digit scale starts from 1001-1850.
